(19) United States
(12) Patent Application Publication
(10) Pub. No.: US 2012/0250626 A1
(43) Pub. Date: Oct. 4, 2012

(54) MOBILE STATION

(75) Inventors: Mikio Iwamura, Minato-ku (JP); Itsuma Tanaka, Yokohama-shi (JP); Keisuke Suzuki, Yokosuka-shi (JP); Masashi Kanauchi, Yokosuka-shi (JP)

(73) Assignee: NTT DOCOMO, INC., Tokyo (JP)

(21) Appl. No.: 13/500,122

(22) PCT Filed: Oct. 5, 2010
(86) PCT No.: PCT/JP2010/067428

§ 371 Date: Jun. 6, 2012

(30) Foreign Application Priority Data
Oct. 5, 2009 (JP) 2009-232037

(51) Int. Cl. H04W 4/00

(52) U.S. Cl. 370/328

(57) ABSTRACT

Even when it is not possible for a radio base station eNB to transmit SSAC barring information in an LTE Rel. 9 scheme, access barring control is performed for “MMTEL mobile originating call”. In a mobile station UE according to the present invention, an AS layer function 10 includes a broadcast information reception unit 11 configured to receive broadcast information including first barring information used in a mobile communication system in an LTE Rel. 8 scheme from a radio base station eNB, an adjustment unit 13 configured to generate second barring information used in a mobile communication system in an LTE Rel. 9 scheme, based on AC of the mobile station UE and the first barring information, and a notification unit 14 configured to notify an MMTEL/IMS layer function 30 of the second barring information, wherein the MMTEL/IMS layer function 30 includes a determination unit 24 configured to determine whether it is possible to perform a call request process, based on the second barring information.

### TECHNICAL FIELD

The present invention relates to a mobile station.

### BACKGROUND ART

In a mobile communication system defined by the 3GPP, each mobile station UE (USIM: User Subscriber Identity Module) possesses at least one of ACs (Access Classes) 0 to 9.

Furthermore, a special mobile station UE (USIM) for network operators, police, or government officials may possess ACs 11 to 15. ACs 11 to 15 are hereinafter called “Special ACs”. Note that AC 10, which is an emergency call AC, is used for issuing a call such as 110 and 119, and is not possessed by the mobile station UE (USIM).

FIG. 11 shows an example of an access barring control method according to an LTE Rel. 8 (Long Term Evolution) scheme.

As shown in FIG. 11, according to the LTE Rel. 8 scheme, a mobile station UE is configured to determine whether or not it is possible to issue a call depending on the type of the call, including an mobile terminating call, an emergency call, an mobile originating call, and a mobile originating call signaling, and also depending on the barring information (ac-BarringInformation) included in the ACs to which the mobile station UE belongs and the broadcast information (SIB2: System Information Block 2), that is, the “Common AC barring information”.

FIG. 12 shows an example of the configuration of SIB2 corresponding to the LTE Rel. 8 scheme.

For example, as regard to an mobile originating call, first of all, the mobile station UE checks whether or not ACs 11 to 15 are possessed, and if ACs 11 to 15 are possessed, the mobile station UE checks the barring information (ac-BarringForSpecialAC) for the “Special ACs” included in the broadcast information (SIB2).

“ac-BarringForSpecialAC” includes one-bit information for each of ACs 11 to 15 (total five bits) expressing whether it is possible to issue a call. When the mobile station UE determines that it is possible to issue a call based on “ac-BarringForSpecialAC” even for any one of ACs 11 to 15 that the mobile station UE possesses, a call request process is started.

On the other hand, when the mobile station UE does not possess ACs 11 to 15, or when it is determined that all of the ACs 11 to 15 possessed by the mobile station UE are not capable of issuing a call based on “ac-BarringForSpecialAC”, the mobile station UE generates a uniform random number between 0 and 1, and determines whether or not the generated random number is smaller than the “ac-BarringFactor” included in the broadcast information (SIB2).

If the generated random number is smaller than “ac-BarringFactor”, the mobile station UE activates the call request process, but in other cases, the mobile station UE activates a prohibition timer for an mobile originating call. When the prohibition timer for an mobile originating call is being activated, the mobile station UE is prohibited from starting the call request process for new mobile originating calls.

Furthermore, the mobile station UE is configured such that when it is attempted to issue a call but this attempt is Rejected by the radio base station eNB, mobile originating calls other than emergency calls are barred for the period of the timer value (that is, during the period the timer T302 is activated) included in RRCConnectionReject.

On the other hand, according to an LTE Rel. 9 scheme, SSAC (Service Specific Access Control) is under discussion. According to SSAC, it is assumed that barring control can be independently enabled in “MMTEL/IMS-voice mobile originating calls”, “MMTEL/IMS-video mobile originating calls”, and “other mobile originating calls”.

Thus, according to the LTE Rel. 9 scheme, the three types of barring information such as “ac-BarringFactor”, “ac-BarringTime”, and “ac-BarringForSpecialAC” are expected to be broadcast independently.

Note that new barring information (“SSAC barring information”) is expected to be broadcast for “MMTEL/IMS-voice mobile originating calls” and “MMTEL/IMS-video mobile originating calls”, and the “Common AC barring information” that is used in the LTE Rel. 8 scheme is expected to be applied as barring information for “other mobile originating calls”.

Here, identification of the type of an mobile originating call in an AS layer function is not desired when protocol separation is taken into consideration, and therefore, barring (SSAC barring) of “MMTEL/IMS-voice mobile originating calls” and “MMTEL/IMS-video mobile originating calls” is expected to be achieved in an MMTEL/IMS layer function.

However, when it is not possible for the radio base station eNB to transmit the SSAC barring information in the LTE Rel. 9 scheme, there is a problem that it is not possible for the mobile station UE to perform access barring control on the “MMTEL/IMS-voice mobile originating call” and the “MMTEL/IMS-video mobile originating call”. Examples thereof include a case where the mobile station UE in the LTE Rel. 9 scheme camps on the radio base station eNB of the LTE Rel. 8 scheme.

### SUMMARY OF THE INVENTION

Therefore, the present invention has been achieved in view of the above-described problems, and an object thereof is to provide a mobile station capable of performing access barring control on “MMTEL/IMS-voice mobile originating call” and “MMTEL/IMS-video mobile originating call” even when it is not possible for a radio base station eNB to transmit SSAC barring information in an LTE Rel. 9 scheme.

Furthermore, another object thereof is to provide a mobile station capable of performing barring control through a common process in an MMTEL/IMS layer function without regard to whether the LTE Rel. 8 scheme or the LTE Rel. 9 scheme is applied.

A first characteristic of the present embodiment is summarized in that a mobile station, comprising, a first layer function that communicates between the mobile station and a radio access network, and a second layer function that terminates between the mobile station and a service control network, in which the first layer function comprises, a broadcast information reception unit configured to receive broadcast information including first barring information used in a mobile communication system in an old scheme from a radio base station, an adjustment unit configured to generate second barring information used in a mobile communication system in a new scheme, based on an access class of the mobile station and the first barring information, and a notification unit configured to notify the second layer function of the second barring information, and the second layer function comprises, a determination unit configured to determine whether or not it is possible to perform a call request process based on the second barring information.

### BRIEF DESCRIPTION OF THE DRAWINGS

FIG. 1 is a diagram showing the entire configuration of a mobile communication system according to a first embodiment of the present invention.

FIG. 2 is a diagram illustrating an example of the configuration of SIB2 transmitted by a radio base station according to the first embodiment of the present invention.

FIG. 3 is a functional block diagram of a mobile station according to the first embodiment of the present invention.

FIG. 4 is a functional block diagram of an AS layer function in a mobile station according to the first embodiment of the present invention.

FIG. 5 is a functional block diagram of an MMTEL/IMS layer function in a mobile station according to the first embodiment of the present invention.

FIG. 6 is a sequence diagram illustrating operations among layer functions in the mobile station according to the first embodiment of the present invention.

FIG. 7 is a flowchart illustrating an operation of the AS layer function in the mobile station according to the first embodiment of the present invention.

FIG. 8 is a flowchart illustrating an operation of the AS layer function in the mobile station according to the first embodiment of the present invention.

FIG. 9 is a flowchart illustrating an operation of the AS layer function in the mobile station according to the first embodiment of the present invention.

FIG. 10 is a flowchart illustrating operations of the MMTEL/IMS layer function and the AS layer function in the mobile station according to the first embodiment of the present invention.

FIG. 11 is a flowchart illustrating an access barring control method in a mobile communication system in an LTE Rel. 8 scheme.

FIG. 12 is diagram illustrating an example of the configuration of SIB2 transmitted by a radio base station in a mobile communication system in an LTE Rel. 8 scheme.

### DETAILED DESCRIPTION

(Configuration of Mobile Communication System According to First Embodiment of the Present Invention)

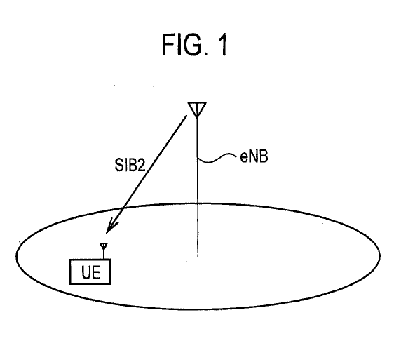

With reference to FIG. 1 to FIG. 4, the configuration of a mobile communication system according to a first embodiment of the present invention will be described.

The mobile communication system according to the present embodiment is a mobile communication system in an LTE Rel. 9 scheme.

As shown in FIG. 1, in the mobile communication system according to the present embodiment, a radio base station eNB is configured to transmit broadcast information, specifically, SIB2 including barring information in an LTE Rel. 8 scheme or barring information (SSAC barring information) in an LTE Rel. 9 scheme.

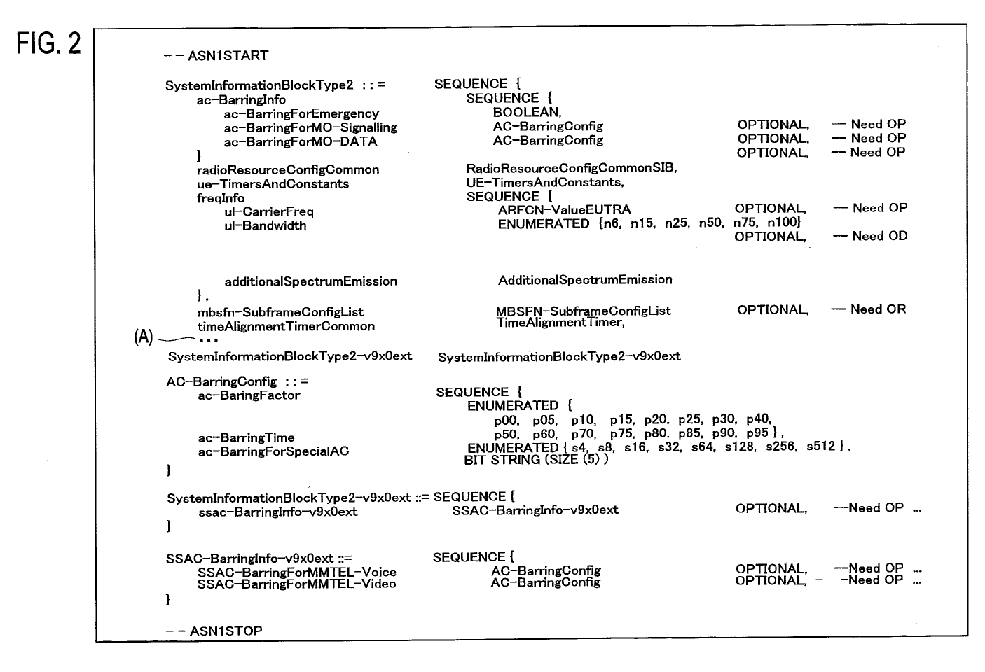

FIG. 2 shows an example of the SIB2 including the barring information (the SSAC barring information) in the LTE Rel. 9 scheme.

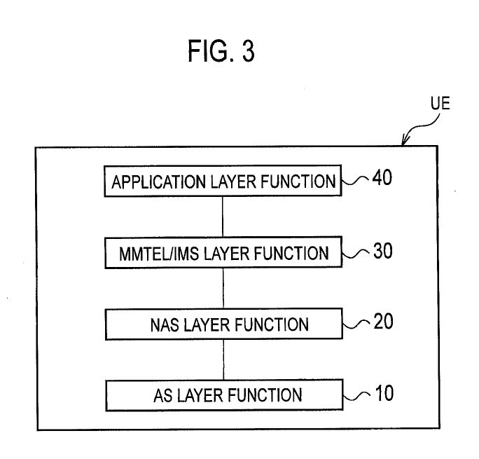

As shown in FIG. 3, a mobile station UE according to the present embodiment includes an AS (Access Stratum) layer function (first layer function) 10 that communicates between the mobile station UE and a radio access network, an NAS (Non Access Stratum) layer function 20 that communicates between the mobile station UE and a core network, an MMTEL/IMS layer function 30 that terminates between the mobile station UE and a service control network (IMS: IP Multimedia Subsystem), and an application layer function 40.

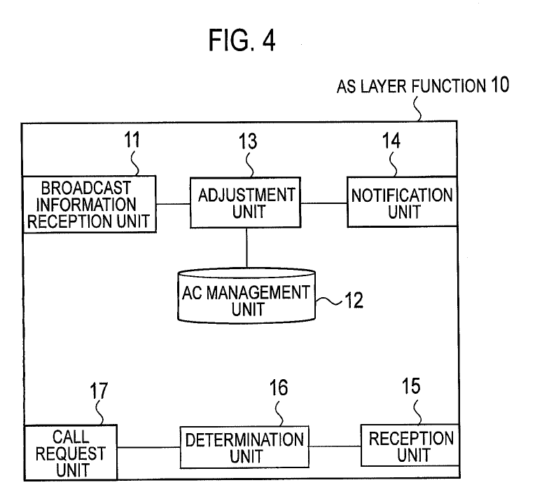

As shown in FIG. 4, the AS layer function 10, that is, an RRC (Radio Resource Control) layer function includes a broadcast information reception unit 11, an AC management unit 12, an adjustment unit 13, a notification unit 14, a reception unit 15, a determination unit 16, and a call request unit 17.

The broadcast information reception unit 11 is configured to receive broadcast information transmitted by the radio base station eNB.

The AC management unit 12 is configured to manage the AC of the mobile station UE. For example, the AC management unit 12 may be provided in the USIM.

The adjustment unit 13 is configured to generate second barring information (mmtel-Voice-BarringFactor, mmtel-Video-BarringFactor, mmtel-Voice-BarringTime, and mmtel-Video-BarringTime) based on the AC of the mobile station and first barring information (ac-BarringFactor, ac-BarringTime, and ac-BarringForSpecialAC) included in the broadcast information (specifically, the SIB2).

Here, the “ac-BarringFactor” indicates a threshold value as the barring information (the first barring information) in the LTE Rel. 8 scheme, and the “ac-BarringTime” indicates time information as the barring information in the LTE Rel. 8 scheme.

Furthermore, the “ac-BarringForSpecialAC” indicates barring control bits (total 5 bits) for ACs 11 to 15 as the barring information (the first barring information) in the LTE Rel. 8 scheme.

Furthermore, the “mmtel-Voice-BarringFactor” indicates a threshold value for “MMTEL-voice mobile originating call” as the barring information (the second barring information, that is, the SSAC barring information) in the LTE Rel. 9 scheme, and the “mmtel-Voice-BarringTime” indicates time information for the “MMTEL-voice mobile originating call” as the barring information in the LTE Rel. 9 scheme.

Moreover, the “mmtel-Video-BarringFactor” indicates a threshold value for “MMTEL-video mobile originating call” as the barring information in the LTE Rel. 9 scheme, and the “mmtel-Video-BarringTime” indicates time information for the “MMTEL-video mobile originating call” as the barring information in the LTE Rel. 9 scheme.

That is, the adjustment unit 13 may be configured to generate the second barring information for each type of mobile originating calls (for example, an MMTEL-voice mobile originating call and an MMTEL-video mobile originating call).

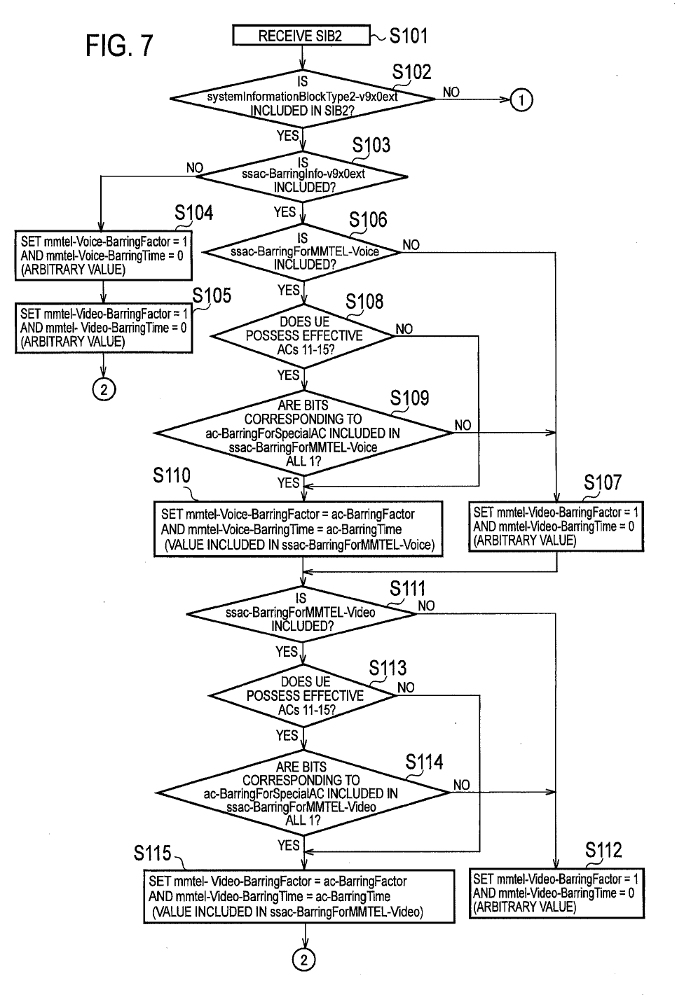

A method for generating the second barring information (the SSAC barring information) will be described later with reference to FIG. 7 to FIG. 9.

The notification unit 14 is configured to notify the MMTEL/IMS layer function 30 of the second barring information generated by the adjustment unit 13.

Here, the notification unit 14 is configured not to notify the MMTEL/IMS layer function 30 of “ac-BarringForSpecialAC” and the ACs of the mobile station UE managed by the AC management unit 12.

Note that the adjustment unit 13 may be configured to generate the second barring information at the timing of receipt of the broadcast information by the broadcast information reception unit 11 rather than at the timing when an MMTEL-voice mobile originating call or an MMTEL-video mobile originating call is made, and the notification unit 14 may be configured to notify the MMTEL/IMS layer function 30 of the second barring information.

Furthermore, the configuration may be such that the second barring information generated by the adjustment unit 13 of the AS layer function 10 is stored, and only when the generated second barring information changes from the previously stored value, the notification unit 14 notifies the MMTEL/IMS layer function 30 of the second barring information.

The reception unit 15 is configured to receive a call request process request sent by the MMTEL/IMS layer function 30.

The determination unit 16 is configured to determine whether or not it is possible to issue a call based on whether or not the period of prohibiting the call request process is occurring (that is, whether or not the timer T302 is being activated) in response to the call request process request from the MMTEL/IMS layer function 30.

The call request unit 17 is configured to issue a call when the determination unit 16 determines that it is possible to issue a call.

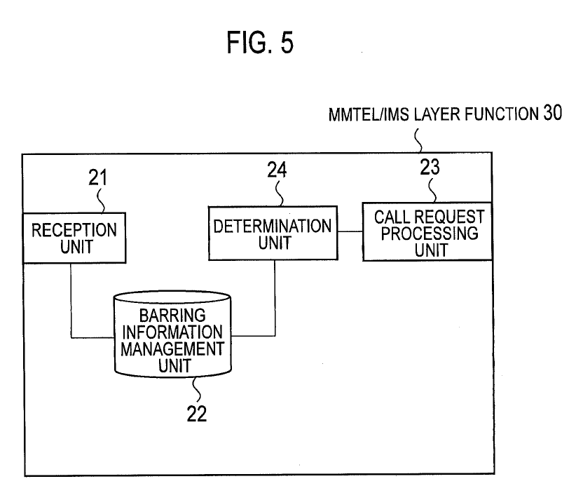

As shown in FIG. 5, the MMTEL/IMS layer function 30 includes a reception unit 21, a barring information management unit 22, a call request processing unit 23, and a determination unit 24.

The reception unit 21 is configured to receive the second barring information that is notified by the AS layer function 10.

The barring information management unit 22 is configured to manage the second barring information received by the reception unit 21.

The call request processing unit 23 is configured to send a call request process start request to the AS layer function 10 when the determination unit 24 determines that it is possible to perform a call request process at the time an MMTEL-voice mobile originating call or an MMTEL-video mobile originating call is made.

The determination unit 24 is configured to determine whether or not it is possible to perform the call request process based on the second barring information managed by the barring information management unit 22. The detailed determination method is described later.

For example, the determination unit 24 may also be configured to determine whether it is possible to perform the call request process, by comparing the threshold value (the mmtel-Voice-BarringFactor or the mmtel-Video-BarringFactor) included in the above-mentioned second barring information with a random number (rand). Here, the random number (rand) is a uniform random number between 0 and 1.

Furthermore, the determination unit 24 may be configured to determine whether or not it is possible to perform the call request process by determining whether or not the period of prohibiting the call request process is occurring (that is, whether or not the timer T3xx is being activated), which is decided based on the time information (mmtel-Voice-BarringTime or mmtel-Video-BarringTime) included in the second barring information.

(Operation of the Mobile Communication System According to The First Embodiment of the Present Invention)

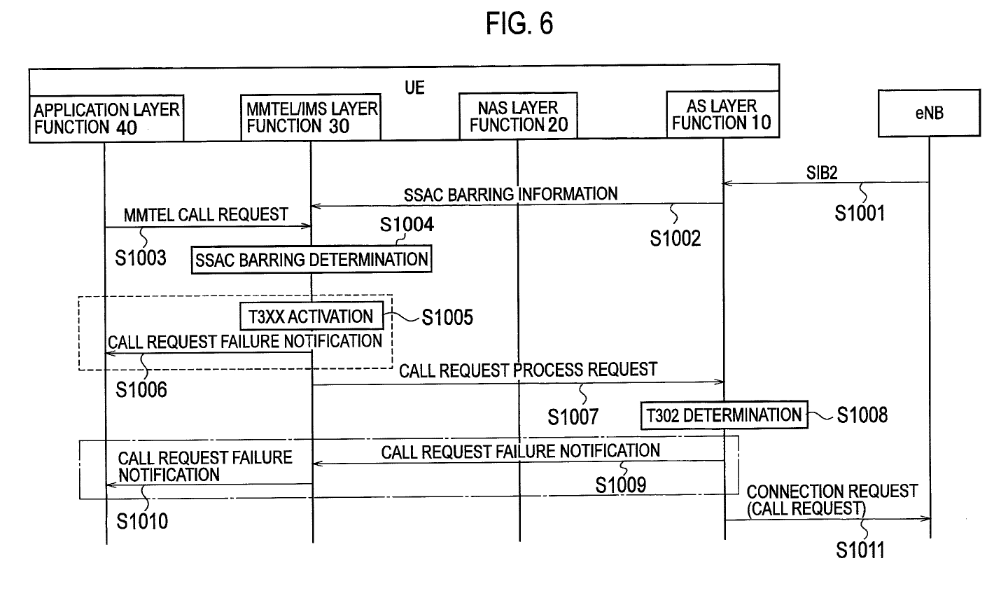

The operation of the mobile communication system according to the first embodiment of the present invention, specifically, the operation inside the mobile station UE according to the first embodiment of the present invention is explained with reference to FIG. 6 through FIG. 10.

As shown in FIG. 6, in step S1001, the AS layer function 10 receives the SIB2 transmitted by the radio base station eNB, and generates the second barring information (the mmtel-Voice-BarringFactor, the mmtel-Video-BarringFactor, the mmtel-Voice-BarringTime, and the mmtel-Video-BarringTime) corresponding to the LTE Rel. 9 scheme based on the first barring information (the ac-BarringFactor, the ac-BarringTime, and the ac-BarringForSpecialAC) included in the SIB2 and corresponding to the LTE Rel. 8 scheme.

Here, the method of generating the second barring information is explained with reference to FIG. 7.

As shown in FIG. 7, if the SIB2 is received in step S101, the AS layer function 10 determines whether “systemInformationBlockType2-v9x0ext (extension broadcast information for the LTE Rel. 9 scheme)” is included in the received SIB2 in step S102.

Specifically, in step S101, the AS layer function 10 determines whether the “systemInformationBlockType2-v9x0ext (the extension broadcast information for the LTE Rel. 9 scheme)” is included in the received SIB2 based on whether a bit corresponding to an “extension marker” expressed by “ . . . (A)” shown in FIG. 2 is “1” or “0” in a bit sequence after ASN.1 encoding of the SIB2 has been performed.

That is, the AS layer function 10 determines that the extension broadcast information is included in the SIB2 when the “extension marker” is “1”, and determines that the extension broadcast information is not included in the SIB2 when the “extension marker” is “0”.

In addition, the “systemInformationBlockType2-v9x0ext (the extension broadcast information for the LTE Rel. 9 scheme)” includes third barring information (the “mmtel-Voice-BarringFactor”, the “mmtel-Video-BarringFactor”, the “mmtel-Voice-BarringTime”, and the “mmtel-Video-BarringTime” shown in FIG. 2).

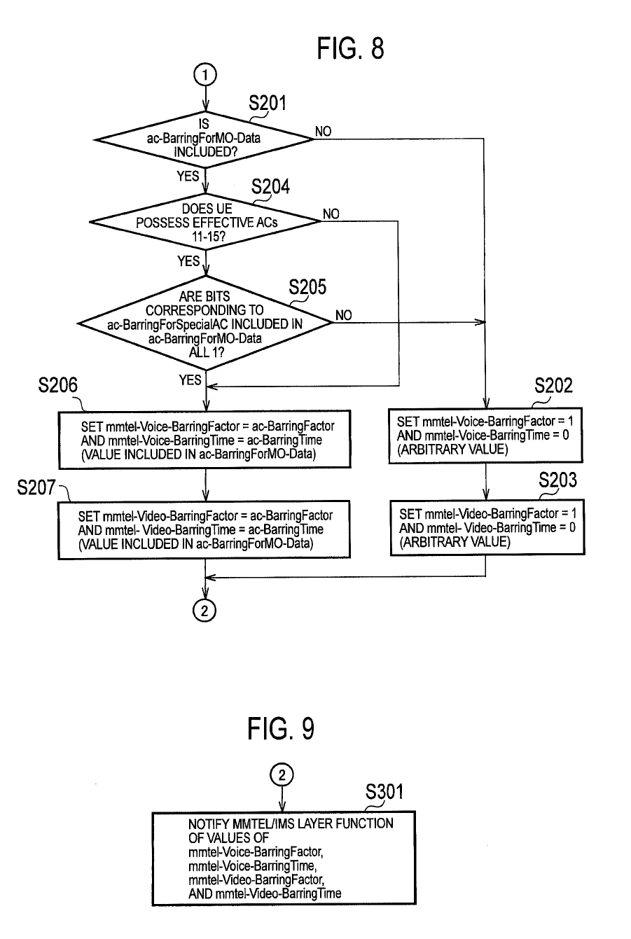

When it is determined that the extension broadcast information is not included in the SIB2, the present operation proceeds to “1” shown in FIG. 8, and when it is determined that the extension broadcast information is included in the SIB2, the present operation proceeds to step S103.

In step S103, the AS layer function 10 determines whether “ssac-BarringInfo-v9x0ext” is included in the received SIB2.

When it is determined that the “ssac-BarringInfo-v9x0ext” is not included in the SIB2, the present operation proceeds to step S104, and when it is determined that the “ssac-BarringInfo-v9x0ext” is included in the SIB2, the present operation proceeds to step S106.

In step S104, the AS layer function 10 sets “1” to the “mmtel-Voice-BarringFactor”, and sets an arbitrary value (for example, “0”) to the “mmtel-Voice-BarringTime”.

Furthermore, in step S105, the AS layer function 10 sets “1” to the “mmtel-Video-BarringFactor”, and sets an arbitrary value (for example, “0”) to the “mmtel-Video-BarringTime”. Then, the present operation proceeds to “2” shown in FIG. 9.

In step S106, the AS layer function 10 determines whether “ssac-BarringForMMTEL-Voice” is included in the received SIB2.

When it is determined that the “ssac-BarringForMMTEL-Voice” is not included in the SIB2, the present operation proceeds to step S107, and when it is determined that the “ssac-BarringForMMTEL-Voice” is included in the SIB2, the present operation proceeds to step S108.

In step S107, the AS layer function 10 sets “1” to the “mmtel-Voice-BarringFactor”, and sets an arbitrary value (for example, “0”) to the “mmtel-Voice-BarringTime”.

In step S108, the AS layer function 10 determines whether or not the mobile station UE owns “Special ACs (ACs 11 to 15)”.

If it is determined that the mobile station UE owns “Special ACs”, the operation proceeds to step S109, and if it is determined that the mobile station UE does not own “Special ACs”, the operation proceeds to step S110.

In step S109, the AS layer function 10 determines whether all the “Special ACs” owned by the mobile station UE have been barred (Barred), that is, all bits corresponding to the “Special ACs” owned by the mobile station UE, of the “ac-BarringForSpecialAC” included in the “ssac-BarringForMMTEL-Voice” are “1”.

When a determination result of step S109 is “YES”, the present operation proceeds to step S110, and when the determination result of step S109 is “NO”, the present operation proceeds to step S107.

In step S110, the AS layer function 10 sets “ac-BarringFactor (a value included in the “ssac-BarringForMMTEL-Voice”)” to the “mmtel-Voice-BarringFactor”, and sets “ac-BarringTime (a value included in the “ssac-BarringForMMTEL-Voice”)” to the “mmtel-Voice-BarringTime”.

In step S111, the AS layer function 10 determines whether “ssac-BarringForMMTEL-Video” is included in the received SIB2.

When it is determined that the “ssac-BarringForMMTEL-Video” is not included in the SIB2, the present operation proceeds to step S112, and when it is determined that the “ssac-BarringForMMTEL-Video” is included in the SIB2, the present operation proceeds to step S113.

In step S112, the AS layer function 10 sets “1” to the “mmtel-Video-BarringFactor”, and sets an arbitrary value (for example, “0”) to the “mmtel-Video-BarringTime”. Then, the present operation proceeds to “2” shown in FIG. 9.

In step S113, the AS layer function 10 determines whether the mobile station UE owns “Special ACs (ACs 11 to 15)”.

If it is determined that the mobile station UE owns “Special ACs”, the operation proceeds to step S114, and if it is determined that the mobile station UE does not own “Special ACs”, the operation proceeds to step S115.

In step S114, the AS layer function 10 determines whether all the “Special ACs” owned by the mobile station UE have been barred (Barred), that is, all bits corresponding to the “Special ACs” owned by the mobile station UE, of the “ac-BarringForSpecialAC” included in the “ssac-BarringForMMTEL-Video” are “1”.

When a determination result of step S114 is “YES”, the present operation proceeds to step S115, and when the determination result of step S114 is “NO”, the present operation proceeds to step S112.

In step S115, the AS layer function 10 sets “ac-BarringFactor (a value included in the “ssac-BarringForMMTEL-Video”)” to the “mmtel-Video-BarringFactor”, and sets “ac-BarringTime (a value included in the “ssac-BarringForMMTEL-Video”)” to the “mmtel-Video-BarringTime”. Then, the present operation proceeds to “2” shown in FIG. 9.

As shown in FIG. 8, in step S201, the AS layer function 10 determines whether “ac-BarringForMO-Data” is included in the received SIB2.

When it is determined that the “ac-BarringForMO-Data” is not included in the SIB2, the present operation proceeds to step S202, and when it is determined that the “ac-BarringForMO-Data” is included in the SIB2, the present operation proceeds to step S204.

In step S202, the AS layer function 10 sets “1” to the “mmtel-Voice-BarringFactor”, and sets an arbitrary value (for example, “0”) to the “mmtel-Voice-BarringTime”.

Furthermore, in step S203, the AS layer function 10 sets “1” to the “mmtel-Video-BarringFactor”, and sets an arbitrary value (for example, “0”) to the “mmtel-Video-BarringTime”. Then, the present operation proceeds to “2” shown in FIG. 9.

In step S204, the AS layer function 10 determines whether or not the mobile station UE owns “Special ACs (ACs 11 to 15)”.

If it is determined that the mobile station UE owns “Special ACs”, the operation proceeds to step S205, and if it is determined that the mobile station UE does not own “Special ACs”, the operation proceeds to step S206.

In step S205, the AS layer function 10 determines whether all the “Special ACs” owned by the mobile station UE have been barred (Barred), that is, all bits corresponding to the “Special ACs” owned by the mobile station UE, of the “ac-BarringForSpecialAC” included in the “ac-BarringForMO-Data” are “1”.

When a determination result of step S205 is “YES”, the present operation proceeds to step S206, and when the determination result of step S205 is “NO”, the present operation proceeds to step S202.

In step S206, the AS layer function 10 sets “ac-BarringFactor (a value included in the “ac-BarringForMO-Data”)” to the “mmtel-Voice-BarringFactor”, and sets “ac-BarringTime (a value included in the “ac-BarringForMO-Data”)” to the “mmtel-Voice-BarringTime”.

Furthermore, in step S207, the AS layer function 10 sets the “ac-BarringFactor (the value included in the “ac-BarringForMO-Data”)” to the “mmtel-Video-BarringFactor”, and sets the “ac-BarringTime (the value included in the “ac-BarringForMO-Data”)” in the “mmtel-Video-BarringTime”. Then, the present operation proceeds to “2” shown in FIG. 9.

As shown in FIG. 9, in step S301 (that is, corresponds to step S1002 of FIG. 6), the AS layer function 10 transmits the “mmtel-Voice-BarringFactor”, the “mmtel-Voice-BarringTime”, the “mmtel-Video-BarringFactor”, and the “mmtel-Video-BarringTime”, which are the generated second barring information (the SSAC barring information), to the MMTEL/IMS layer function 30.

Returning to FIG. 6, if the MMTEL-voice mobile originating call or the MMTEL-video mobile originating call is generated, that is, if an MMTEL call request is received from the application layer function 40, the MMTEL/IMS layer function 30 performs SSAC barring determination, that is, the MMTEL/IMS layer function 30 determines whether it is possible to perform the call request process based on the “mmtel-Voice-BarringFactor”, the “mmtel-Voice-BarringTime”, the “mmtel-Video-BarringFactor”, and the “mmtel-Video-BarringTime”, which are the above-mentioned second barring information, in step S1003.

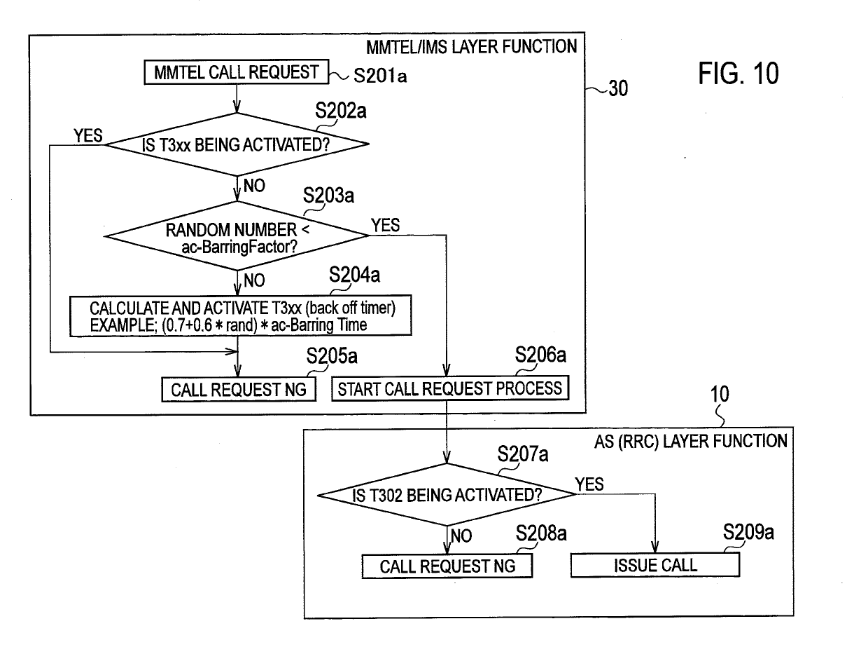

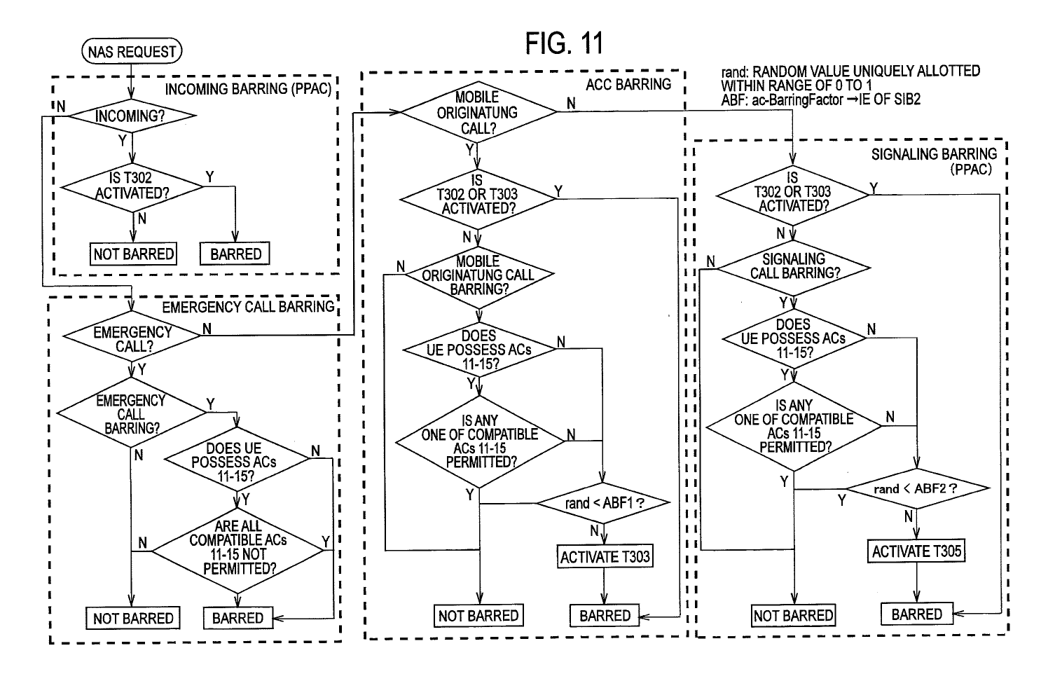

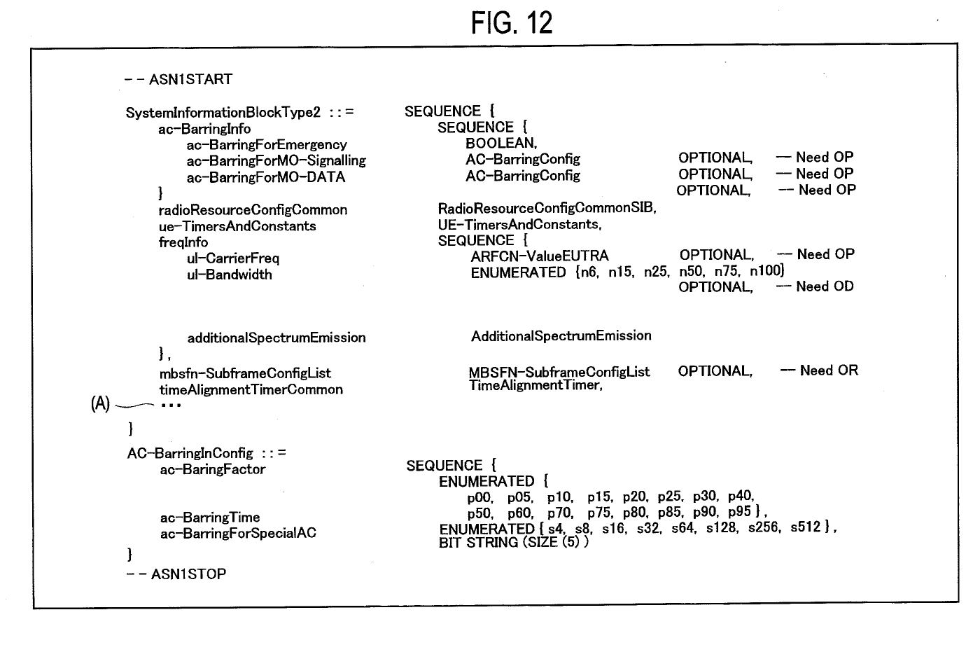

Hereinafter, a method for performing the SSAC barring determination will be described with reference to FIG. 10.

As shown in FIG. 10, if the MMTEL call request is received from the application layer function 40 in step S201a, the MMTEL/IMS layer function 30 determines whether a timer Txx is being activated in step S202a.

When it is determined that the timer Txx is being activated, the present operation proceeds to step S205a, and when it is determined that the timer Txx is not being activated, the present operation proceeds to step S203a.

In step S203a, the MMTEL/IMS layer function 30 compares the random number (rand) with the “mmtel-Voice-BarringFactor (the threshold value)” or the “mmtel-Video-BarringFactor”, which is the second barring information, according to a call type of “MMTEL/IMS-Voice” or “MMTEL/IMS-Video”. Here, the random number (rand) is a uniform random number between 0 and 1.

When it is determined that the random number (rand) is smaller than the “mmtel-Voice-BarringFactor (the threshold value)” or the “mmtel-Video-BarringFactor”, the present operation proceeds to step S206a, and when it is determined that the random number (rand) is not smaller than the “mmtel-Voice-BarringFactor (the threshold value)” or the “mmtel-Video-BarringFactor”, the present operation proceeds to step S204a.

In step S204a (corresponds to step S1005 of FIG. 6), the MMTEL/IMS layer function 30 activates a timer T3xx.

Here, the MMTEL/IMS layer function 30 may use a setting value of the timer T3xx as a value of the “mmtel-Voice-BarringTime” or the “mmtel-Video-BarringTime”, use the setting value of the timer T3xx as a value calculated by (0.7+06×“random number (u)”)×“mmtel-Voice-BarringTime” or (0.7+06×“random number (u)”)×“mmtel-Video-BarringTime”, or use the setting value of the timer T3xx as a predetermined fixed value. Here, the “random number (u)” is a uniform random number between 0 and 1.

In step S205a (corresponds to step S1006 of FIG. 6), the MMTEL/IMS layer function 30 determines that it is not possible to perform the call request process, and transmits a call request failure notification to the application layer function 40.

In step S206a (corresponds to step S1007 of FIG. 6), the MMTEL/IMS layer function 30 determines that it is possible to perform the call request process, and transmits a call request process request to the AS layer function 10 via the NAS layer function 20.

In step S207a (corresponds to step S1008 of FIG. 6), the AS layer function 10 determines whether or not the timer T302 is being activated.

If it is determined that the timer T302 is being activated, the operation proceeds to step S208a (corresponds to step S1009 of FIG. 5), and if it is determined that the timer T302 is not activated, the operation proceeds to step S209a (corresponds to step S1011 of FIG. 6).

In step S208a, the AS layer function 10 determines that it is not possible to issue a call, and then, transmits a call request failure notification to the upper layer (to the MMTEL/IMS layer function 30 via the NAS layer function 20). Following this, in step S1010 of FIG. 6, the MMTEL/IMS layer function 30 transmits a call request failure notification to the application layer function 40.

On the other hand, in step S209a, the AS layer function 10 determines that it is possible to issue a call, and issues a call, that is, transmits a connection request to the radio base station eNB.

Note that when the AS layer function 10 receives RRCConnectionReject (Reject signal) from the radio base station eNB in response to the connection request, the AS layer function 10 sets T302 to the value included in the RRCConnectionReject, and activates the T302.

At this time, the AS layer function 10 may be configured to simultaneously notify the MMTEL/IMS layer function 30 of the value of the T302, and the MMTEL/IMS layer function 30 may be configured to determine whether or not the timer T302 in the step S207a is being activated.

Alternatively, the MMTEL/IMS layer function 30 may set T3xx to the value of the timer T302 received from the AS layer function 10, and then activate the T3xx.

In the above example, whether the “systemInformationBlockType2-v9x0ext” is included in the received SIB2 is determined, and whether the “SSAC barring information” in the LTE Rel. 9 scheme or the “Common AC barring information” in the LTE Rel. 8 scheme is applied to the “MMTEL/IMS-Voice” or the “MMTEL/IMS-Video” is changed according to the determination result.

Alternatively, another information element explicitly indicating whether the extension broadcast information is included may be allowed to be included in the broadcast information, and the above determination may be performed based on this information element.

Furthermore, alternatively, an information element explicitly indicating whether the “SSAC barring information” in the LTE Rel. 9 scheme or the “Common AC barring information” in the LTE Rel. 8 scheme is applied to the “MMTEL/IMS-Voice” or the “MMTEL/IMS-Video” may be allowed to be included in the broadcast information, and the above determination may be performed based on this information element.

(Operation and Effect of the Mobile Communication System According to the First Embodiment of the Present Invention)

In accordance with the mobile communication system according to the first embodiment of the present invention, even when it is not possible for the radio base station eNB to transmit the SSAC barring information in the LTE Rel. 9 scheme, it is possible for the mobile station UE to bar the “MMTEL-voice mobile originating call” or the “MMTEL-video mobile originating call” based on the “ac-BarringInfo” in the LTE Rel. 8 scheme, resulting in the avoidance of congestion due to the “MMTEL-voice mobile originating call” or the “MMTEL-video mobile originating call”.

Furthermore, in accordance with the mobile communication system according to the first embodiment of the present invention, it is possible to unify interaction between the AS (RRC) layer function and the MMTEL/IMS layer function, resulting in the simplification of the barring determination process in the MMTEL/IMS layer function.

The characteristics of the present embodiment as described above may be expressed as follows.

The first characteristic of the present embodiment is summarized in that a mobile station UE includes: an AS layer function 10 which communicates between the mobile station UE and a radio access network; and an MMTEL/IMS layer function 30 terminated between the mobile station UE and a service control network, wherein the AS layer function 10 includes: a broadcast information reception unit 11 configured to receive broadcast information (SIB2) including first barring information (ac-BarringFactor and ac-BarringTime) used in a mobile communication system in an LTE Rel. 8 scheme (an old scheme) from a radio base station eNB; an AC management unit 12 configured to manage AC of the mobile station UE; an adjustment unit configured to generate second barring information (mmtel-Voice-BarringFactor, mmtel-Video-BarringFactor, mmtel-Voice-BarringTime, and mmtel-Video-BarringTime) used in a mobile communication system in an LTE Rel. 9 scheme (a new scheme), based on the AC of the mobile station UE and the first barring information (ac-BarringFactor and ac-BarringTime); and a notification unit 14 configured to notify the MMTEL/IMS layer function 30 of the second barring information, wherein the MMTEL/IMS layer function 30 includes: a determination unit 24 configured to determine whether it is possible to perform a call request process, based on the second barring information.

In the first characteristic of the present embodiment, the adjustment unit 13 may be configured to determine whether extension broadcast information of the mobile communication system in the LTE Rel. 8 scheme is included in the broadcast information (SIB2) received from the radio base station eNB, to generate the second barring information based on the first barring information when it is determined that the extension broadcast information is not included, and to generate the second barring information based on third barring information (mmtel-Voice-BarringFactor, mmtel-Video-BarringFactor, mmtel-Voice-BarringTime, and mmtel-Video-BarringTime) included in the extension broadcast information when it is determined that the extension broadcast information is included.

In the first characteristic of the present embodiment, the AS layer function 10 may further include a determination unit 16 configured to determine whether or not it is possible to issue a call based on whether or not the period of prohibiting the call request process is occurring (that is, whether or not the timer T302 is being activated) in response to the call request process request from the MMTEL/IMS layer function 30.

In the first characteristic of the present embodiment, when receiving a Reject signal from the radio base station in response to the connection request, the determination unit 16 of the AS layer function 10 may be configured to activate the timer T302 that manages the period of prohibiting the call request process based on the value included in the Reject signal.

In the first characteristic of the present embodiment, the determination unit 24 of the MMTEL/IMS layer function 30 may be configured to determine whether or not it is possible to perform the call request process by comparing the threshold value (ac-BarringFactor) included in the second barring information with a random number (rand).

In the first characteristic of the present embodiment, the determination unit 24 of the MMTEL/IMS layer function 30 may be configured to determine whether or not it is possible to perform the call request process by determining whether or not the period of prohibiting the call request process is occurring (that is, whether or not the timer T3xx is being activated), which is decided based on the time information (ac-BarringTime) included in the second barring information.

In the first characteristic of the present embodiment, the determination unit 24 of the MMTEL/IMS layer function 30 may be configured to activate the timer T3xx that manages the period of prohibiting the call request process based on the time information included in the second barring information, when it determines that the call request process cannot be performed.

In the first characteristic of the present embodiment, the adjustment unit 13 of the AS layer function 10 may be configured to generate the second barring information for each type of mobile originating calls (for example, MMTEL-voice mobile originating call and MMTEL-video mobile originating call).

In the first characteristic of the present embodiment, the configuration may be such that the adjustment unit 13 of the AS layer function 10 generates the second barring information, and the notification unit 14 of the AS layer function 10 notifies the MMTEL/IMS layer function 30 of the second barring information, when the broadcast information is received by the broadcast information reception unit 11 of the AS layer function 10.

In the first characteristic of the present embodiment, the configuration may be such that the second barring information generated by the adjustment unit 13 of the AS layer function 10 is stored, and only when the generated second barring information changes from the previously stored value, the notification unit 14 of the AS layer function 10 notifies the MMTEL/IMS layer function 30 of the second barring information.

In addition, the operation of the above-mentioned the radio base station eNB or mobile station UE may be implemented by hardware, may also be implemented by a software module executed by a processor, or may further be implemented by the combination of the both.

The software module may be arranged in a storage medium of an arbitrary format such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

Such a storage medium is connected to the processor so that the processor can write and read information into and from the storage medium. Such a storage medium may also be accumulated in the processor. Such storage medium and processor may be arranged in an ASIC. Such ASIC may be arranged in the radio base station eNB or mobile station UE. As a discrete component, such storage medium and processor may be arranged in the radio base station eNB or mobile station UE.

Thus, the present invention has been specifically explained by using the above-mentioned embodiments; however, it is obvious that for persons skilled in the art, the present invention is not limited to the embodiments explained herein. The present invention can be implemented as corrected and modified modes without departing from the gist and the scope of the present invention defined by the claims. Therefore, the description of the specification is intended for explaining the example only and does not impose any limited meaning to the present invention.

### INDUSTRIAL APPLICABILITY

As described above, in accordance with the present invention, it is possible to provide a mobile station capable of performing access barring control on “MMTEL/IMS-voice mobile originating call” and “MMTEL/IMS-video mobile originating call” even when it is not possible for a radio base station eNB to transmit SSAC barring information in an LTE Rel. 9 scheme.

1. A mobile station, comprising:
a first layer function that communicates between the mobile station and a radio access network, and
a second layer function that terminates between the mobile station and a service control network, wherein
the first layer function comprises:
a broadcast information reception unit configured to receive broadcast information including first barring information used in a mobile communication system in an old scheme from a radio base station;
an adjustment unit configured to generate second barring information used in a mobile communication system in a new scheme, based on an access class of the mobile station and the first barring information; and
a notification unit configured to notify the second layer function of the second barring information, and
the second layer function comprises:
a determination unit configured to determine whether or not it is possible to perform a call request process based on the second barring information.

2. The mobile station according to claim 1, wherein
the adjustment unit is configured to determine whether extension broadcast information of the mobile communication system in the new scheme is included in the broadcast information received from the radio base station,
is configured to generate the second barring information based on the first barring information when it is determined that the extension broadcast information is not included, and
is configured to generate the second barring information based on third barring information included in the extension broadcast information when it is determined that the extension broadcast information is included.

3. The mobile station according to claim 1, wherein
the first layer function further comprises: a determination unit configured to determine, in response to the call request process request from the second layer function, whether or not it is possible to issue a call based on whether or not the period of prohibiting the call request process is occurring.

4. The mobile station according to claim 3, wherein
when receiving a Reject signal from a radio base station in response to a connection request, the determination unit of the first layer function is configured to activate a timer for managing the period of prohibiting the call request process based on the value included in the Reject signal.

5. The mobile station according to claim 1, wherein
the determination unit of the second layer function is configured to perform the determination by comparing a threshold value included in the second barring information with a random number.

6. The mobile station according to claim 1, wherein
the determination unit of the second layer function is configured to perform the determination by determining whether or not the period of prohibiting the call request process is occurring, which is decided based on the time information included in the second barring information.

7. The mobile station according to claim 6, wherein
the determination unit of the second layer function is configured to activate a timer for managing the period of prohibiting the call request process based on the time information included in the second barring information, when it determines that the call request process cannot be performed.

8. The mobile station according to claim 1, wherein
the adjustment unit is configured to generate the second barring information for each type of mobile originating calls.

9. The mobile station according to claim 1, wherein
when the broadcast information is received by the broadcast information reception unit, the adjustment unit is configured to generate the second barring information, and the notification unit is configured to notify the second layer function of the second barring information.

10. The mobile station according to claim 1, wherein
the second barring information generated by the adjustment unit is stored, and only when the generated second barring information changes from the previously stored value, the notification unit is configured to notify the second layer function of the second barring information.

11. The mobile station according to claim 1, wherein the first layer function is an AS layer function, and
the second layer function is an MMTEL layer function or an IMS layer function.
